(19) United States
(12) Patent Application Publication
(10) Pub. No.: US 2010/0149682 A1
(43) Pub. Date: Jun. 17, 2010

(54) DYNAMIC PITCH AND ROLL SENSING IN HARD DISK DRIVES

(75) Inventors: Vinod Sharma, Los Altos, CA (US); Dongman Kim, Campbell, CA (US)

Correspondence Address: IRELL & MANELLA LLP, 1800 AVENUE OF THE STARS, SUITE 900, LOS ANGELES, CA, 90067, US

(73) Assignee: Samsung Electronics Co., Ltd.

(21) Appl. No.: 12/337,172

(22) Filed: Dec. 17, 2008

(51) Int. Cl. G11B 5/58; G11B 5/33

(52) U.S. Cl. 360/77.01; 360/110; G9B/5.107

(57) ABSTRACT

A head for a hard disk drive that includes a primary read element and a first sensor read element coupled to a head body. The first sensor read element is offset from the primary read element. The first sensor read element provides a read signal that can be analyzed to determine a pitch of the head. The head may also have a second sensor read element that is offset from the first sensor read element. The second sensor read element provides a read signal that can also be analyzed to determine a pitch of the head. Read signals of the first and second sensor read elements can be analyzed to determine a roll of the head.

### BACKGROUND OF THE INVENTION

1. Field of the Invention

The present invention relates to determining a pitch and roll of a head in a hard disk drive.

2. Background Information

Hard disk drives contain a plurality of magnetic heads that are coupled to rotating disks. The heads write and read information by magnetizing and sensing the magnetic fields of the disk surfaces. Each head is attached to a flexure arm to create a subassembly commonly referred to as a head gimbal assembly (“HGA”). The HGA's are suspended from an actuator arm. The actuator arm has a voice coil motor that can move the heads across the surfaces of the disks.

During operation, each head is separated from a corresponding disk surface by an air bearing. The air bearing eliminates mechanical interference between the head and the disks. The strength of the magnetic field from the disk is inversely proportional to the flying height of the head relative to the disk. Reduced spacing results in a stronger magnetic field on the disk, and vice versa.

The flying height of a head is a function of a pitch and roll of the head body. It is desirable to determine the pitch and roll of the head during operation to insure proper head stability. Understanding pitch and roll is particularly important for small flying heights on the order of a few nanometers. Pitch and roll can be determined by attaching a sensor, such as a piezoelectric transducer, to the flexure arm of the HGA. Data from such a sensor may not be entirely accurate.

### BRIEF SUMMARY OF THE INVENTION

A head for a hard disk drive that includes a primary read element and a first sensor read element coupled to a head body. The first sensor read element is offset from the primary read element.

### BRIEF DESCRIPTION OF THE DRAWINGS

FIG. 1 is a top view of an embodiment of a hard disk drive;

FIG. 2 is an illustration of a head of the disk drive;

FIG. 3 is an enlarged view showing read elements of the drive;

FIG. 4 is a cross-section of the head showing the read elements;

FIG. 5 is a schematic of an electrical circuit for the hard disk drive.

### DETAILED DESCRIPTION

Disclosed is a head for a hard disk drive that includes a primary read element and a first sensor read element coupled to a head body. The first sensor read element is offset from the primary read element. The first sensor read element provides a read signal that can be analyzed to determine a pitch of the head. The head may also have a second sensor read element that is offset from the first sensor read element. Read signals of the first and second sensor read elements can be analyzed to determine a roll of the head. The read elements can be embedded into the head body to place the elements in close proximity to the flying height of the head.

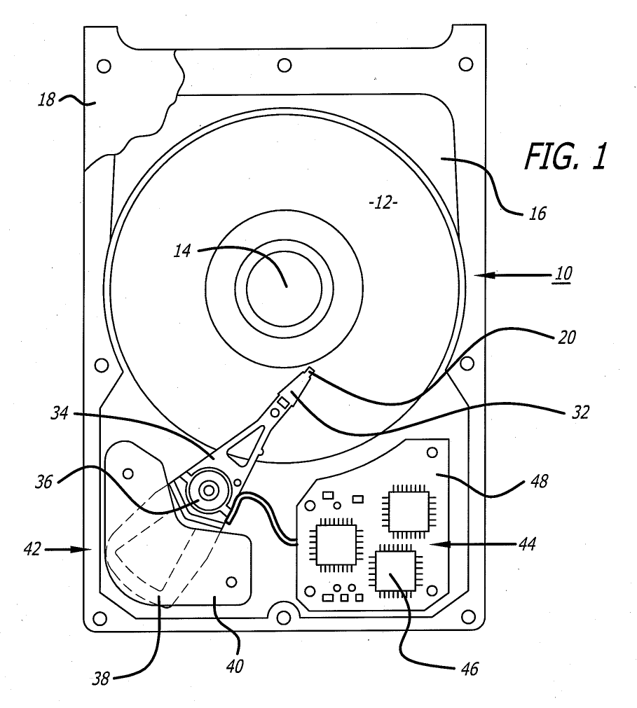

Referring to the drawings more particularly by reference numbers, FIG. 1 shows an embodiment of a hard disk drive 10. The disk drive 10 may include one or more magnetic disks 12 that are rotated by a spindle motor 14. The spindle motor 14 may be mounted to a base plate 16. The disk drive 10 may further have a cover 18 that encloses the disks 12.

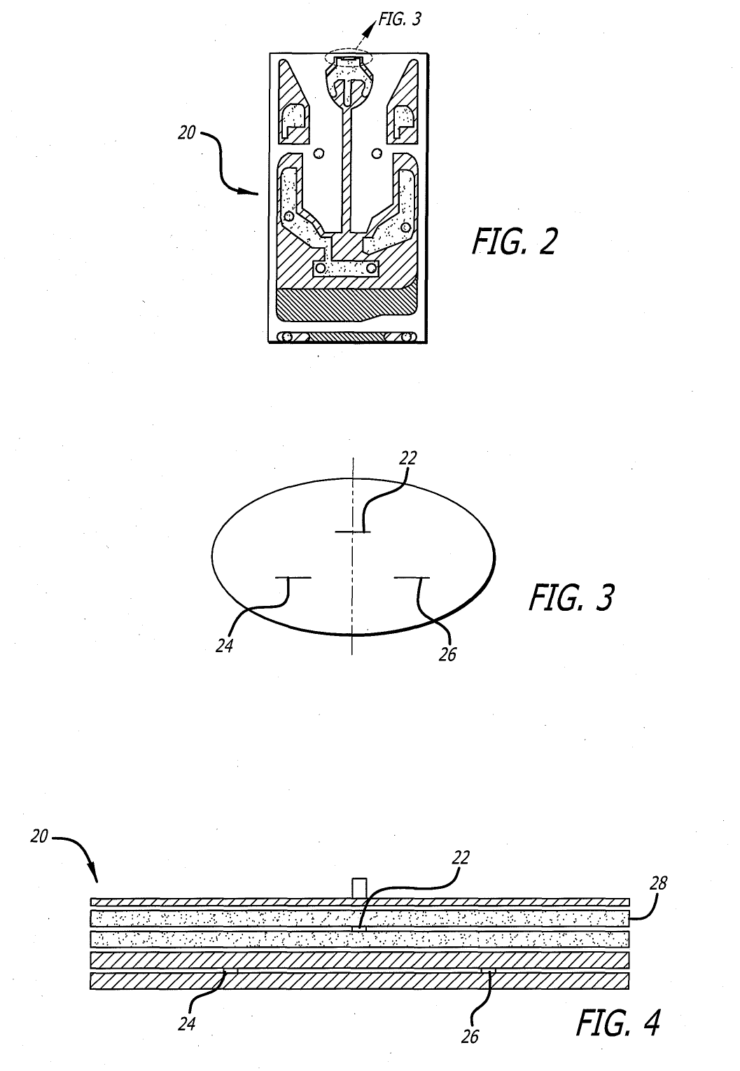

The disk drive 10 may include a plurality of heads 20 located adjacent to the disks 12. As shown in FIGS. 2 and 3 the heads 20 may have a primary read element 22 and a write element (not shown). The write element magnetizes the disk 12 to write data. The read element 22 senses the magnetic fields of the disks 12 to read data. By way of example, the read element 22 may be constructed from a magneto-resistive material that has a resistance which varies linearly with changes in magnetic flux. Each head may include a heater element (not shown). A current can be provided to the heater element to expand the heads and vary the head flying height. These types of heads are commonly referred to as fly-on-demand (“FOD”) heads.

Each head may also have a first sensor read element 24 and a second sensor read element 26. The first and second sensor read elements 24 and 26 can each provide a read signal that is analyzed to determine certain characteristics of the head such as pitch, roll and flying height. The sensor read elements 24 and 26 are offset from the primary read element 22 along a length of the head 20. This offset allows for the determination of a head pitch. The read signals from the first and second read sensor elements 24 and 26 can be analyzed to determine a roll of the head. The position of the two read sensors from a longitudinal center line C_{L} may be equally spaced to minimize the complexity in determining the head pitch and roll. The first and second sensor read elements 24 and 26 may be equally spaced from a longitudinal center line C_{L} so that read signals from the elements can be analyzed to determine a roll of the head.

As shown in FIG. 4 the primary read element 22 and the sensor read elements 24 and 26 may be embedded into the body 28 of the head. The sensor elements 24 and 26 are preferably in a different layer than the primary read element 22.

Referring to FIG. 1, each head 20 may be gimbal mounted to a flexure arm 32 as part of a head gimbal assembly (HGA). The flexure arms 32 are attached to an actuator arm 34 that is pivotally mounted to the base plate 16 by a bearing assembly 36. A voice coil 38 is attached to the actuator arm 34. The voice coil 38 is coupled to a magnet assembly 40 to create a voice coil motor (VCM) 42. Providing a current to the voice coil 38 will create a torque that swings the actuator arm 34 and moves the heads 20 across the disks 12.

The hard disk drive 10 may include a printed circuit board assembly 44 that includes a plurality of integrated circuits 46 coupled to a printed circuit board 48. The printed circuit board 46 is coupled to the voice coil 38, heads 20 and spindle motor 14 by wires (not shown).

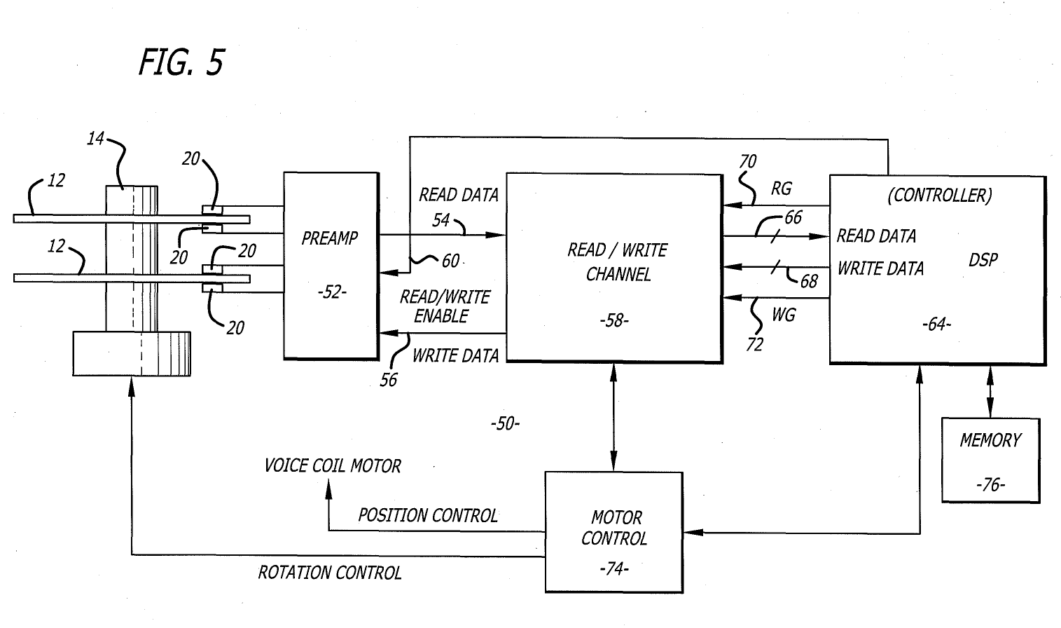

FIG. 5 shows an embodiment of an electrical circuit 50 for reading and writing data onto the disks 12. The circuit 50 may include a pre-amplifier circuit 52 that is coupled to the heads 20. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 58 is connected to a controller 64 through read and write channels 66 and 68, respectively, and read and write gates 70 and 72, respectively. The read gate 70 is enabled when data is to be read from the disks 12. The write gate 72 is to be enabled when writing data to the disks 12. The controller 64 may be a digital signal processor that operates in accordance with a software routine, including a routine(s) to write and read data from the disks 12. The read/write channel circuit 62 and controller 64 may also be connected to a motor control circuit 74 which controls the voice coil motor 36 and spindle motor 14 of the disk drive 10. The controller 64 may be connected to a non-volatile memory device 76. By way of example, the device 76 may be a read only memory (“ROM”) that contains instructions that are read by the controller 64.

The controller 64 can analyze read signals from the read elements 22, 24 and 26 to determine different fly characteristics of the heads. For example, the read signals provided by one or both sensor read elements and primary read element can be analyzed to determine the pitch of the head. The read signals from both sensor read elements, and/or one or both of the sensor read elements and the primary read element can be analyzed to determine a roll of the head. For example, the roll may be the difference between the two flying heights of the sensor read elements. Likewise, the pitch may be determined from the difference of the flying heights between the primary read element and one or both of the sensor read elements. A change in pitch can also be used to determine an altitude of the drive. Each of the read elements is preferably calibrated to determine the absolute flying height of each element.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A head for a hard disk drive, comprising:
a body;
a primary read element coupled to said body; and,
a first sensor read element coupled to said body and offset from said primary read element.

2. The head of claim 1, further comprising a second sensor read element.

3. The head of claim 2, wherein said first and second sensor read elements are equally spaced from a longitudinal center line of said body.

4. The head of claim 1, wherein said primary read element and said first sensor read element are embedded into said body.

5. A hard disk drive, comprising:
a disk that contains a signal;
a spindle motor that rotates said disk;
a head that is coupled to said disk, said head including;
a body;
a primary read element coupled to said body;
a first sensor read element coupled to said body and offset from said primary read element; and,
a controller coupled to said head.

6. The disk drive of claim 5, further comprising a second sensor read element.

7. The disk drive of claim 6, wherein said first and second sensor read elements are equally spaced from a longitudinal center line of said body.

8. The disk drive of claim 5, wherein said primary read element and said first sensor read element are embedded into said body.

9. The disk drive of claim 5, wherein said controller determines a pitch of said body from a read signal provided by either said first sensor read element and/or said second read element.

10. The disk drive of claim 6, wherein said controller determines a roll of said body from read signals provided by said first and second sensor read elements.

11. A method for determining a fly characteristic of a head in a hard disk drive, comprising:
receiving a read signal from a first sensor read element offset from a primary read element of a head; and,
analyzing the read signal to determine a fly characteristic of the head.

12. The method of claim 11, wherein the fly characteristic is a pitch of the head.

13. The method of claim 11, further comprising receiving a read signal from a second sensor read element and analyzing the read signals from the first and second sensor elements to determine a roll of the head.
